(19) United States
(12) Patent Application Publication
(10) Pub. No.: US 2025/0264224 A1
(43) Pub. Date: Aug. 21, 2025

(54) LOCK STRUCTURE AND COOKING APPLIANCE

(71) Applicants: Guangdong Midea Kitchen Appliances Manufacturing Co., Ltd., Foshan (CN); Midea Group Co., Ltd., Foshan (CN)

(72) Inventors: Xingzhong HUANG, Foshan (CN); Jingjing ZHANG, Foshan (CN); Kunmao WANG, Foshan (CN); Yajian WANG, Foshan (CN)

(21) Appl. No.: 19/198,471

(22) Filed: May 5, 2025

Related U.S. Application Data
(63) Continuation of application No. PCT/CN2024/103996, filed on Jul. 5, 2024.

(30) Foreign Application Priority Data
Jul. 6, 2023 (CN) 202310825443.3

(51) Int. Cl. F24C 15/02; E05B 47/00; E05B 65/00

(52) U.S. Cl. CPC F24C 15/022; E05B 47/0004; E05B 65/00; E05B 2047/0076

(57) ABSTRACT

A lock structure includes a mounting member, a locking member, and a limiting member. The mounting member is connected to one of a door assembly or a cavity assembly, and the other of the door assembly or the cavity assembly is provided with a connecting part. The locking member is connected to the mounting member, and the locking member is configured to move between a locked position and an unlocked position. In the locked position, the locking member is connected to the connecting part. In the unlocked position, the locking member is separated from the connecting part. When the locking member is located in the locked position, and the limiting member operates in a first state, the limiting member is configured to limit the locking member. When the limiting member operates in a second state, the limiting member releases the locking member.

### CROSS-REFERENCE TO RELATED APPLICATIONS

This application is a continuation of International Application No. PCT/CN2024/103996, filed on Jul. 5, 2024, which claims priority to Chinese Patent Application No. 202310825443.3 filed with China National Intellectual Property Administration on Jul. 6, 2023 and entitled “LOCK STRUCTURE AND COOKING APPLIANCE”, the entire contents of which are herein incorporated by reference.

### FIELD

The present application relates to the technical field of food processing equipment, and particularly relates to a lock structure and a cooking appliance.

### BACKGROUND

After a cooking appliance finishes cooking, users can directly open a door assembly. At this moment, the temperature of the food that has just been cooked is usually high, and there is a possibility of scalding the users. This is especially likely to cause accidents when children use the cooking appliance to cook food.

### SUMMARY

The present application aims to solve at least one of the technical problems existing in the prior art.

In view of this, according to a first aspect, the present application provides a lock structure for a cooking appliance. The cooking appliance comprises a cavity assembly and a door assembly. The lock structure comprises: a mounting member, and the mounting member is configured to be connected to one of the door assembly and the cavity assembly, and the other one of the door assembly and the cavity assembly is provided with a connecting part; a locking member, and the locking member is connected to the mounting member, and the locking member can move between a locked position and an unlocked position, when in the locked position, the locking member is configured to be connected to the connecting part, and when in the unlocked position, the locking member is separated from the connecting part; a limiting member, and the limiting member is connected to the mounting member, when the locking member is located in the locked position and the limiting member operates in a first state, the limiting member is configured to limit the locking member, and when the limiting member operates in a second state, the limiting member releases the limitation on the locking member.

In addition, the lock structure in the above technical solution provided according to the present application can further comprise the following additional technical features.

In some technical solutions, the locking member is provided with a plug-in part, and the locking member is rotatably connected to the mounting member. When in the locked position, the plug-in part is configured to engage with the connecting part, and the plug-in part can rotate under the pulling of the connecting part, to make the locking member rotate towards the unlocked position.

In some technical solutions, the locking member is provided with a to-be-pushed part, and the to-be-pushed part is configured to be pushed by the connecting part, to make the locking member rotate towards the locked position.

In some technical solutions, a first side of the plug-in part is provided with a limiting surface, and a second side of the plug-in part is provided with a inclined surface. The limiting surface is configured to limit the connecting part. A first end of the plug-in part is distal from a rotation center of the locking member. From the first end of the plug-in part to the second end of the plug-in part, a distance between the limiting surface and the inclined surface increases.

In some technical solutions, the lock structure further comprises: a rotating shaft, which is connected to the mounting member, and the locking member is provided with a shaft hole, and the rotating shaft passes through the shaft hole; a boss, which is connected to the rotating shaft, and the locking member is located between the boss and the mounting member, the locking member is provided with a limiting groove, the limiting groove is in communication with the shaft hole, when the boss is misaligned with the limiting groove, the boss is configured to prevent the locking member from disengaging from the rotating shaft, when the boss is aligned with the limiting groove, the boss can pass through the limiting groove.

In some technical solutions, one of the locking member and the limiting member is provided with a slot. When the locking member is in the locked position and the limiting member operates in the first state, the other one of the locking member and the limiting member is inserted into the slot.

In some technical solutions, the limiting member comprises: a solenoid valve body, which is connected to the mounting member; an output shaft, which is connected to the solenoid valve body. In the first state, the output shaft moves to a first position relative to the solenoid valve body, and the output shaft limits the locking member; in the second state, the output shaft moves to a second position, and the output shaft is separated from the locking member.

In some technical solutions, the limiting member further comprises a guiding member, and the guiding member is connected to the mounting member, the guiding member is provided with a guiding hole, and the output shaft passes through the guiding hole.

In some technical solutions, the output shaft comprises: a shaft body, which is connected to the solenoid valve body; a first limiting part, which is connected to the shaft body, and the first limiting part passes through the guiding hole and is configured to limit the locking member; a second limiting portion, which is connected to the first limiting part, and when the output shaft is at the first position, the second limiting part contacts the side of the guiding member away from the locking member.

In some technical solutions, the limiting member further comprises an elastic member which is connected to the output shaft and the solenoid valve body. When the output shaft is at the first position, the elastic member is in an elastically deformed state; when the output shaft is at the second position, the elastic member is in an original state.

According to a second aspect, the present application provides a cooking appliance, which comprises: a cavity assembly; a door assembly, which is connected to the cavity assembly in an openable and closable manner; the lock structure as described in any of the above technical solutions; and the mounting member is arranged on one of the cavity assembly and the door assembly, and a connecting part is provided on the other one of the cavity assembly and the door assembly.

In some technical solutions, based on the mounting member being provided on the cavity assembly, the connecting part comprises a door hook.

The additional aspects and advantages of the present application will become apparent in the following description, or be learned through the practice of the present application.

### BRIEF DESCRIPTION OF THE DRAWINGS

The above and/or additional aspects and advantages of the present application will become apparent and easily understandable from the description of the embodiments in conjunction with the accompanying drawings,

FIG. 1 shows a schematic view of the structure of a cooking appliance in some embodiments of the present application;

FIG. 2 shows an enlarged view of part A in FIG. 1;

FIG. 3 shows an exploded view of a cooking appliance in some embodiments of the present application; and

FIG. 4 shows an exploded view of a lock structure in some embodiments of the present application.

Reference signs: 100 lock structure, 110 mounting member, 120 locking member, 121 plug-in part, 122 to-be-pushed part, 123 limiting surface, 124 inclined surface, 125 shaft hole, 126 limiting groove, 127 slot, 130 limiting member, 131 solenoid valve body, 132 output shaft, 133 guiding member, 134 guiding hole, 135 shaft body, 136 first limiting part, 137 second limiting part, 138 elastic member, 140 rotating shaft, 150 boss, 200 cavity assembly, 300 door assembly, 310 connecting part, 311 jack, 320 door seal, 330 door tooth, 340 door surface.

### DETAILED DESCRIPTION OF THE APPLICATION

To more clearly understand the above purposes, features and advantages of the present application, the present application will be further detailed hereinafter in combination with the accompanying drawings and embodiments. It should be indicated that in the case of no conflict, the embodiments and the features in the embodiments of the present application can be combined with each other.

Many details are illustrated in the following description for the convenience of a thorough understanding to the present application, but the present application can further be implemented using other embodiments other than these described herein. Therefore, the protection scope of the present application is not limited to the specific embodiments disclosed in the following text.

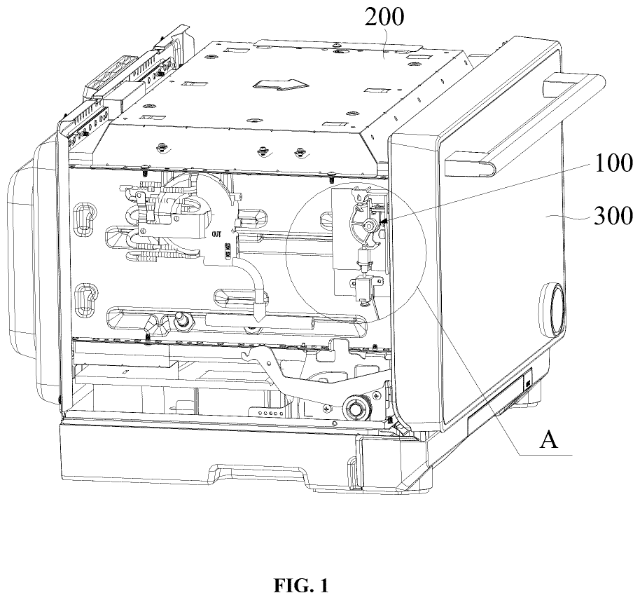

A lock structure 100 and a cooking appliance provided according to some embodiments of the present application are described hereinafter by referring to FIG. 1 to FIG. 4.

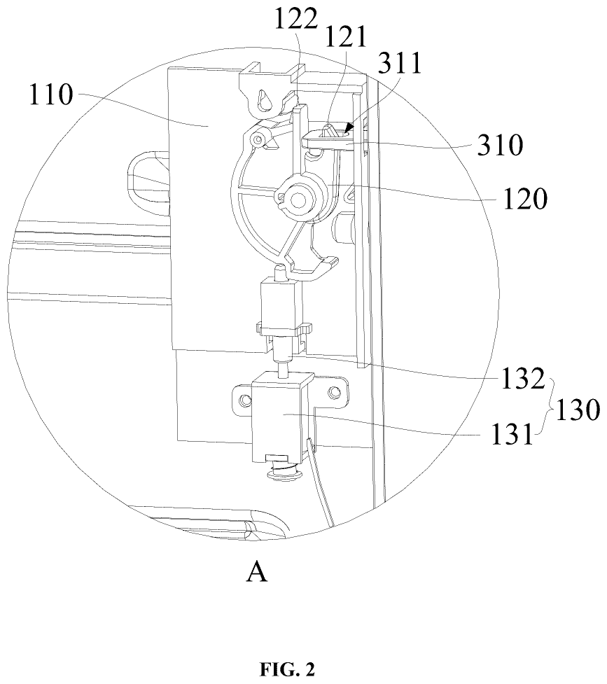

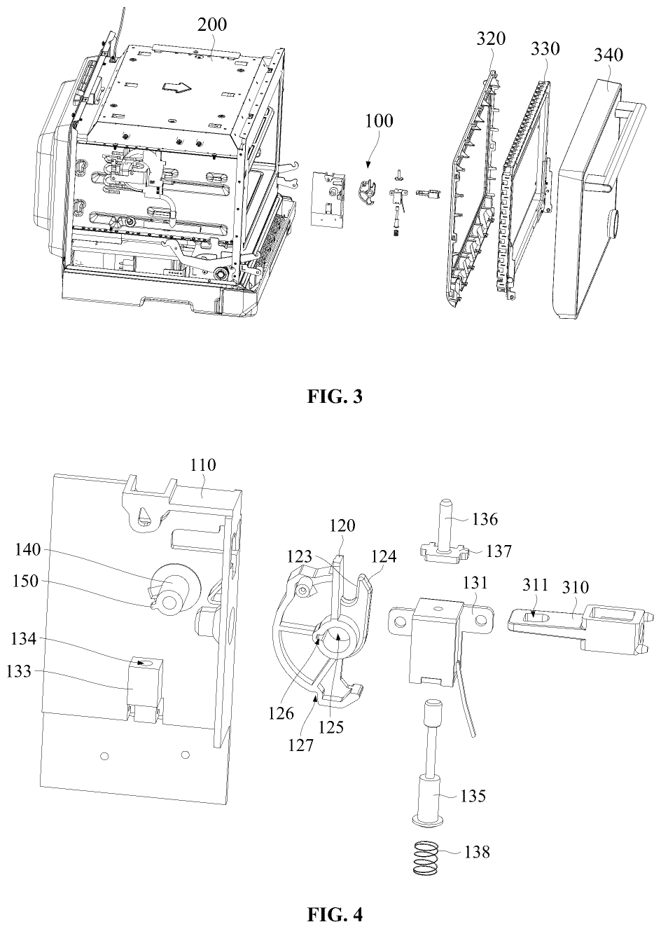

In combination with FIG. 1, FIG. 2 and FIG. 3, in the embodiments of the present application, a lock structure 100 is provided, and the lock structure 100 is for a cooking appliance. The cooking appliance comprises a cavity assembly 200 and a door assembly 300 connected to each other. The lock structure 100 comprises a mounting member 110, a locking member 120 and a limiting member 130; the mounting member 110 is configured to be connected to one of the door assembly 300 and the cavity assembly 200, and the other one of the door assembly 300 and the cavity assembly 200 is provided with a connecting part 310; the locking member 120 is connected to the mounting member 110, and the locking member 120 can move between a locked position and an unlocked position, when in the locked position, the locking member 120 is configured to be connected to the connecting part 310, and when in the unlocked position, the locking member 120 is separated from the connecting part 310; the limiting member 130 is connected to the mounting member 110, when the locking member 120 is located in the locked position and the limiting member 130 operates in a first state, the limiting member 130 is configured to limit the locking member 120, and when the limiting member 130 operates in a second state, the limiting member 130 releases the limitation on the locking member 120.

The lock structure 100 provided in some embodiments is for a cooking appliance, and the cooking appliance comprises the door assembly 300 and the cavity assembly 200. The mounting member 110, the locking member 120 and the limiting member 130 serve as a child lock and play a role of assisting the connection between the door assembly 300 and the cavity assembly 200. By adding the lock structure 100 to one of the door assembly 300 and the cavity assembly 200, when the door assembly 300 closes the cavity assembly 200, the lock structure 100 restricts the door assembly 300 from opening the cavity assembly 200, to realize the function of a child lock.

In some embodiments, it is taken as an example for illustration that the lock structure 100 is arranged on the cavity assembly 200.

When opening and closing the door, the user can control the limiting member 130 to lock and unlock the cooking appliance. Specifically, when the door assembly 300 closes the cavity assembly 200, the locking member 120 is in the locked position, and the locking member 120 is connected to the connecting part 310 in the door assembly 300. At this moment, the user can control the limiting member 130 to switch to the first state, the limiting member 130 operating in the first state limits the locking member 120, and at this moment, the locking member 120 cannot move relative to the door assembly 300. Before opening the cavity assembly 200, the limiting member 130 maybe switched to the second state. The limiting member 130 in the second state is separated from the locking member 120, at this moment, the limiting member 130 no longer limits the locking member 120, and the user can open the cavity assembly 200 by pulling the door assembly 300. Opening the cavity assembly 200 via two steps of operation, may improve the safety of using the cooking appliance.

In the present application, a child lock structure is added to the cooking appliance. When the locking member 120 moves to a first position, the limiting member 130 limits the movement of the locking member 120, the locking member 120 limits the position of the door assembly 300, thus making it difficult for the door assembly 300 to open the cavity assembly 200, then keeping the door body in a locked state, and as a result, the cavity assembly 200 cannot be opened.

To open the cavity assembly 200, the limitation on the door assembly 300 may be released by the locking member 120. Therefore, the limitation on the locking member 120 may be first released by the limiting member 130. When the limiting member 130 is separated from the locking member 120, the locking member 120 can move relative to the mounting member 110, and the limitation on the door assembly 300 by the locking member 120 can be released. Therefore, when opening the door, the user may first switch the limiting member 130 to the second state, which is the first step of the operation, and then the user pulls the door assembly 300 to open the cavity assembly 200, which is the second step of the operation. Through the two steps of operation, the difficulty of opening the door is increased.

After the cooking process of the cooking appliance is completed, the temperature of the food in the cooking cavity is high, at this moment, there is a risk of scalding if the user directly opens the door to take out the food. Therefore, with the above-mentioned lock structure 100 in the present application, if the user wants to open the cavity assembly 200, the two steps of operation for opening the door may be performed before opening the cavity assembly 200. In this way, firstly, it can play a role of reminding the user to a certain extent, and secondly, it can prevent the occurrence of the situation where children accidentally open the cavity assembly 200, and then greatly improve the safety of using this cooking appliance.

The locking member 120 and the limiting member 130 are installed on the mounting member 110, and thus the lock structure 100 has an integral structure, which facilitates the assembly of the lock structure 100.

In some embodiments, the first state and the second state refer to the operating states of the limiting member 130.

As shown in FIG. 2, in some embodiments, the locking member 120 is provided with a plug-in part 121, and the locking member 120 is rotatably connected to the mounting member 110. When in the locked position, the plug-in part 121 is configured to engage with the connecting part 310. The plug-in part 121 can rotate under the pulling of the connecting part 310, and the locking member 120 rotates towards the unlocked position.

The locking member 120 can rotate relative to the mounting member 110 between the locked position and the unlocked position. When the limiting member 130 is in the first state, the limiting member 130 limits the locking member 120, at this moment, the locking member 120 cannot rotate relative to the mounting member 110, and the locking member 120 can limit the door assembly 300. When the limiting member 130 is in the second state, the limiting member 130 releases the limitation on the locking member 120, at this moment, the locking member 120 can rotate relative to the mounting member 110, and the locking member 120 releases the limitation on the door assembly 300.

In the following embodiments, it is taken as an example for illustrative description that the connecting part 310 is provided on the door assembly 300, and the principle of providing the connecting part 310 on the cavity assembly 200 is the same, and will not be repeated herein again.

When the door assembly 300 closes the cavity assembly 200, the locking member 120 is connected to the connecting part 310. When the limiting member 130 limits the locking member 120, the locking member 120 cannot rotate relative to the mounting member 110, therefore, it is difficult for the locking member 120 to separate from the connecting part 310, at this moment, even if the door assembly 300 is pulled, it is difficult to open the cavity assembly 200. When the limiting member 130 releases the limitation on the locking member 120, the locking member 120 can rotate freely. When the user pulls the door assembly 300, the connecting part 310 can pull the plug-in part 121, and the locking member 120 can rotate under the pulling of the connecting part 310. As the locking member 120 rotates, the plug-in part 121 gradually separates from the connecting part 310, and the plug-in part 121 no longer limits the connecting part 310, and the cavity assembly 200 can be opened smoothly.

As shown in FIG. 2, in some embodiments, the locking member 120 is provided with a to-be-pushed part 122. The to-be-pushed part 122 is configured to be pushed by the connecting part 310, to make the locking member 120 rotate towards the locked position.

During the door opening process, the plug-in part 121 is pulled by the connecting part 310 and rotates, and the locking member 120 can rotate to the unlocked position. When the door is closed, in order to enable the locking member 120 to limit the position of the connecting part 310, it is necessary to ensure that the locking member 120 is in the locked position. The rotation of the locking member 120 from the unlocked position to the locked position is pushed by the connecting part 310.

Specifically, the locking member 120 is provided with the to-be-pushed part 122. During the door closing process, the connecting part 310 comes into contact with the to-be-pushed part 122. As the connecting part 310 moves, the to-be-pushed part 122 is pushed by the connecting part 310. Therefore, as the connecting part 310 moves, the locking member 120 rotates from the unlocked position to the locked position. When the door assembly 300 closes the cavity assembly 200, the locking member 120 just rotates to the locked position, and at this moment, the plug-in part 121 engages with the connecting part 310.

By pushing the to-be-pushed part 122 by the connecting part 310, the door assembly 300 and the locking member 120 are linked. During the door closing process, the locking member 120 can be pushed to rotate to the locked position, and there is no need to provide an electric driving structure to drive the locking member 120, which is beneficial to simplifying the structure of the cooking appliance.

In a possible application, the connecting part 310 is provided with a jack 311, and the plug-in part 121 can be inserted into the jack 311. During the door opening process, the plug-in part 121 gradually rotates out of the jack 311. During the door closing process, the movement of the connecting part 310 is synchronized with the rotation of the locking member 120, and the plug-in part 121 gradually inserts into the jack 311.

In other embodiments, the lock structure 100 further comprises a motor. The locking member 120 is connected to the motor, and the motor is configured to drive the locking member 120 to rotate between the locked position and the unlocked position.

In combination with FIG. 2 and FIG. 4, in some embodiments, a first side of the plug-in part 121 is provided with a limiting surface 123, and a second side of the plug-in part 121 is provided with an inclined surface 124. The limiting surface 123 is configured to limit the position of the connecting part 310. A first end of the plug-in part 121 is distal from a rotation center of the locking member 120. From the first end of the plug-in part 121 to the second end of the plug-in part 121, a distance between the limiting surface 123 and the inclined surface 124 increases.

The limiting surface 123 and the inclined surface 124 are respectively provided on two sides of the plug-in part 121 away from each other. When the plug-in part 121 engages with the connecting part 310, the limiting surface 123 limits the position of the connecting part 310, and it is difficult for the connecting part 310 to separate from the plug-in part 121, thus ensuring that the cavity assembly 200 is in a locked state.

From the first end of the plug-in part 121 to the second end of the plug-in part 121, the distance between the limiting surface 123 and the inclined surface 124 increases. When the connecting part 310 pulls the plug-in part 121, the distance between the inclined surface 124 and the connecting part 310 remains basically unchanged. In this way, a certain gap can be ensured between the inclined surface 124 and the connecting part 310, and then this avoids the contact between the inclined surface 124 and the connecting part 310, and prevents the rotation of the plug-in part 121 from interfering with the movement of the connecting part 310, and ensures the stability of the cooperation between the door assembly 300 and the lock structure 100.

In combination with FIG. 2 and FIG. 4, in some embodiments, the lock structure 100 further comprises a rotating shaft 140 and a boss 150. The rotating shaft 140 is connected to the mounting member 110. The locking member 120 is provided with a shaft hole 125, and the rotating shaft 140 passes through the shaft hole 125. The boss 150 is connected to the rotating shaft 140, and the locking member 120 is located between the boss 150 and the mounting member 110. The locking member 120 is provided with a limiting groove 126, and the limiting groove 126 is in communication with the shaft hole 125. When the boss 150 is misaligned with the limiting groove 126, the boss 150 is configured to prevent the locking member 120 from disengaging from the rotating shaft 140. When the boss 150 is opposite to the limiting groove 126, the boss 150 can pass through the limiting groove 126.

The rotating shaft 140 is provided on the mounting member 110. The rotating shaft 140 and the mounting member 110 can be of an integrally formed structure. The shaft hole 125 is formed in the locking member 120, and the rotating shaft 140 passes through the shaft hole 125, thus enabling the locking member 120 to rotate around the rotating shaft 140.

The boss 150 is provided on the side part of the rotating shaft 140, and the boss 150 and the rotating shaft 140 can be of an integrally formed structure. Specifically, a part of the rotating shaft 140 passes through the shaft hole 125, and the boss 150 is provided on the part of the rotating shaft 140 that passes through the shaft hole 125. Therefore, the locking member 120 is located between the boss 150 and the mounting member 110, and the boss 150 can limit the position of the locking member 120, thus preventing the locking member 120 from disengaging from the rotating shaft 140 and ensuring the connection stability between the locking member 120 and the rotating shaft 140.

The limiting groove 126 is further provided in the locking member 120, and the limiting groove 126 communicates with the shaft hole 125. When the boss 150 and the limiting groove 126 are misaligned, the boss 150 limits the locking member 120. When the boss 150 is opposite to the limiting groove 126, the locking member 120 can be pulled along the axial direction of the rotating shaft 140, and the boss 150 can pass through the limiting groove 126, and the locking member 120 can be disassembled.

The cooperation between the boss 150 and the limiting groove 126 is beneficial to improving the convenience of disassembling and assembling the locking member 120.

In combination with FIG. 2 and FIG. 4, in some embodiments, a slot 127 is provided on one of the locking member 120 and the limiting member 130. When the locking member 120 is in the locked position and the limiting member 130 is in the first state, the other one of the locking member 120 and the limiting member 130 is inserted into the slot 127.

When the limiting member 130 limits the locking member 120, there is a plug-in cooperation relationship between the limiting member 130 and the locking member 120. Illustratively, the locking member 120 is provided with the slot 127, and the limiting member 130 is inserted into the slot 127 to limit the locking member 120. In some embodiments, if the slot 127 is provided in the limiting member 130 and the locking member 120 is inserted into the slot 127, the locking member 120 can further be limited.

In some embodiments, the slot 127 is provided in the locking member 120. When the locking member 120 is in the locked position, the slot 127 is opposite to the limiting member 130, the limiting member 130 operates in the first state, and a part of the limiting member 130 is inserted into the slot 127, and the limiting member 130 limits the rotation of the locking member 120.

In combination with FIGS. 2 and 4, in some embodiments, the limiting member 130 comprises a solenoid valve body 131 and an output shaft 132. The solenoid valve body 131 is connected to the mounting member 110, and the output shaft 132 is connected to the solenoid valve body 131. In the first state, the output shaft 132 moves to the first position relative to the solenoid valve body 131, and the output shaft 132 limits the locking member 120. In the second state, the output shaft 132 moves to the second position, and the output shaft 132 is separated from the locking member 120.

In some embodiments, the limiting member 130 is a solenoid valve. When the solenoid valve is powered on, the output shaft 132 extends out of the solenoid valve body 131. When the solenoid valve is powered off, at least a part of the output shaft 132 retracts into the solenoid valve body 131. In some embodiments, the first state of the solenoid valve refers to the powered-on state of the solenoid valve, and the second state of the solenoid valve refers to the powered-off state of the solenoid valve.

When the locking member 120 rotates to the locked position, the solenoid valve is powered on, and the solenoid valve body 131 drives the output shaft 132 to move, and the output shaft 132 moves to a position where it limits the locking member 120. For example, the output shaft 132 is inserted into the slot 127 in the locking member 120. Since the solenoid valve is fixed on the mounting member 110 and its position is not likely to change, the output shaft 132 limits the rotation of the locking member 120.

When the door is to be opened, the user can control the solenoid valve to be powered off. The output shaft 132 will separate from the locking member 120, and the locking member 120 can rotate freely.

In a possible application, the axial direction of the output shaft 132 extends along a plumb direction. When the solenoid valve is powered off, the output shaft 132 freely falls under its own gravity and gradually retracts into the solenoid valve body 131.

In a possible application, an unlocking button can be set on the cooking appliance. The unlocking button can be a physical button or a virtual button. After the user presses the unlocking button, the solenoid valve is powered on or powered off. In some embodiments, the user can control the power on and power off of the solenoid valve through an APP.

As shown in FIG. 2 and FIG. 4, in some embodiments, the limiting member 130 further comprises a guiding member 133. The guiding member 133 is connected to the mounting member 110. The guiding member 133 is provided with a guiding hole 134, and the output shaft 132 passes through the guiding hole 134.

The guiding member 133 is installed on the mounting member 110. For example, the guiding member 133 is locked to the mounting member 110 by locking elements such as screws, and the guiding member 133 is not likely to move relative to the mounting member 110.

The guiding hole 134 is provided in the guiding member 133, and the output shaft 132 passes through the guiding hole 134, and the output shaft 132 can slide within the guiding hole 134. The guiding hole 134 plays a role of limiting the output shaft 132. When the output shaft 132 limits the locking member 120, if the door assembly 300 is subjected to a pulling force at this moment, the connecting part 310 will exert a pulling force on the locking member 120, and the locking member 120 has a tendency to rotate. At this moment, the output shaft 132 will be pushed by the locking member 120. By limiting the output shaft 132 through the guiding hole 134, the output shaft 132 is not prone to deformation, which is beneficial to improving the limiting stability of the output shaft 132 to the locking member 120.

The guiding hole 134 can further play a guiding role for the output shaft 132, to ensure that the output shaft 132 can stably cooperate with the locking member 120 and improving the stability of the cooperation between the output shaft 132 and the locking member 120.

As shown in FIG. 2 and FIG. 4, in some embodiments, the output shaft 132 comprises a shaft body 135, a first limiting part 136, and a second limiting part 137. The shaft body 135 is connected to the solenoid valve body 131. The first limiting part 136 is connected to the shaft body 135. The first limiting part 136 passes through the guiding hole 134 and is configured to limit the position of the locking member 120. The second limiting part 137 is connected to the first limiting part 136. When the output shaft 132 is in the first position, the second limiting part 137 contacts the side of the guiding member 133 that faces away from the locking member 120.

The shaft body 135 is connected to the solenoid valve body 131, and the solenoid valve body 131 is configured to drive the shaft body 135 to move. The first limiting part 136 is connected to the shaft body 135. The first limiting part 136 can pass through the guiding hole 134 and slide within the guiding hole 134. The second limiting part 137 is connected to the first limiting part 136. Along the radial direction of the output shaft 132, the cross-sectional area of the second limiting part 137 is greater than that of the first limiting part 136. The first limiting part 136 can pass through the guiding hole 134, while the second limiting part 137 cannot extend into the guiding hole 134. When the shaft body 135 limits the locking member 120, the second limiting part 137 contacts the side of the guiding member 133 that faces away from the locking member 120. The second limiting part 137 is configured to limit the movement stroke of the shaft body 135, and this prevents the occurrence of the situation where the first limiting part 136 moves excessively and causes damage to the locking member 120.

In a possible application, the first limiting part 136 is locked to the shaft body 135 by locking elements such as screws, and the second limiting part 137 and the first limiting part 136 are of an integrally formed structure.

In combination with FIG. 2 and FIG. 4, in some embodiments, the limiting member 130 further comprises an elastic member 138. The elastic member 138 is connected to the output shaft 132 and the solenoid valve body 131. When the output shaft 132 is in the first position, the elastic member 138 is in a state of elastic deformation, and when the output shaft 132 is in the second position, the elastic member 138 is in an original state.

The elastic member 138 is located between the output shaft 132 and the solenoid valve body 131. When the output shaft 132 moves relative to the solenoid valve body 131, the output shaft 132 will cause the elastic member 138 to undergo elastic deformation. When the solenoid valve is powered off, the elastic member 138 drives the output shaft 132 to move and return to its original position.

Specifically, the elastic member 138 is sleeved on the output shaft 132, and the two ends of the elastic member 138 are respectively connected to the output shaft 132 and the solenoid valve body 131. When the output shaft 132 moves relative to the solenoid valve body 131, the output shaft 132 drives the first end of the elastic member 138 to move, causing the elastic member 138 to be compressed. When the solenoid valve is powered off, the output shaft 132 freely falls under the action of gravity. At this moment, the elastic member 138 further provides a restoring push force to the output shaft 132, which can effectively prevent the occurrence of the situation where the output shaft 132 fails to return to its original position due to jamming, and is beneficial to improving the working stability of the solenoid valve.

In combination with FIG. 1, FIG. 2 and FIG. 3, in the embodiments of the present application, a cooking appliance is provided, which comprises the cavity assembly 200, the door assembly 300 and the lock structure 100 in any of the above embodiments. The door assembly 300 is connected to the cavity assembly 200 in an openable and closable manner. The mounting member 110 is provided on one of the cavity assembly 200 and the door assembly 300, and the connecting part 310 is provided on the other one of the cavity assembly 200 and the door assembly 300. By adding the lock structure 100 on either the door assembly 300 or the cavity assembly 200, when the door assembly 300 closes the cavity assembly 200, the lock structure 100 restricts the door assembly 300 from opening the cavity assembly 200, thus realizing the function of a child lock.

In some embodiments, it is taken as an example for illustrative description that the lock structure 100 is provided on the cavity assembly 200.

When opening and closing the door, the user can control the limiting member 130 to lock and unlock the cooking appliance. Specifically, when the door assembly 300 closes the cavity assembly 200, the locking member 120 is in the locked position, and the locking member 120 is connected to the connecting part 310 of the door assembly 300. At this moment, the user can control the limiting member 130 to switch to the first state. The limiting member 130 operating in the first state limits the locking member 120, and at this moment, the locking member 120 cannot move relative to the door assembly 300. Before opening the cavity assembly 200, the limiting member 130 may be switched to the second state. The limiting member 130 in the second state is separated from the locking member 120, at this moment, the limiting member 130 no longer limits the locking member 120, and the user can open the cavity assembly 200 by pulling the door assembly 300. Opening the cavity assembly 200 via two steps of operation may improve the safety of using the cooking appliance.

In the present application, a child lock structure is added to the cooking appliance. When the locking member 120 moves to the first position, the limiting member 130 limits the movement of the locking member 120. The locking member 120 limits the door assembly 300, making it difficult for the door assembly 300 to open the cavity assembly 200, and thus keeping the door body in a locked state, and as a result, the cavity assembly 200 cannot be opened.

In order to open the cavity assembly 200, it the limitation on the door assembly 300 may be released by the locking member 120. Therefore, the limitation on the locking member 120 may be first released by the limiting member 130. When the limiting member 130 is separated from the locking member 120, the locking member 120 can move relative to the mounting member 110, and the limitation on the door assembly 300 by the locking member 120 can be released. Therefore, when opening the door, the user may first switch the limiting member 130 to the second state, which is the first step of the operation, and then the user pulls the door assembly 300 to open the cavity assembly 200, which is the second step of the operation. Through the two steps of operation, the difficulty of opening the door is increased.

After the cooking process of the cooking appliance is completed, the temperature of the food in the cooking cavity is high, at this moment, there is a risk of scalding if the user directly opens the door to take out the food. Therefore, with the above-mentioned lock structure 100 in the present application, if the user wants to open the cavity assembly 200, the two steps of operation for opening the door may be performed before opening the cavity assembly 200. In this way, firstly, it can play a role of reminding the user to a certain extent, and secondly, it can prevent the occurrence of the situation where children accidentally open the cavity assembly 200, and then greatly improve the safety of using this cooking appliance.

The locking member 120 and the limiting member 130 are installed on the mounting member 110, and thus the lock structure 100 has an integral structure, which facilitates the assembly of the lock structure 100.

In some embodiments, the door assembly 300 comprises a door seal 320, a door tooth 330 and a door surface 340 which are connected in sequence.

In some embodiments, based on the mounting member 110 being arranged on the cavity assembly 200, the connecting part 310 comprises a door hook.

When the mounting member 110 is arranged on the cavity assembly 200, at this time, the locking member 120 is configured to cooperate with the door hook.

Specifically, the mounting member 110 is locked on the cavity assembly 200. When the door assembly 300 closes the cavity assembly 200, the locking member 120 engages with the door hook. The locking member 120 limits the movement of the door hook, and at this moment, it is difficult for the user to directly pull the door assembly 300. When the locking member 120 releases the limitation on the door hook, the user can open the cavity assembly 200 by pulling the door assembly 300.

By providing the lock structure 100 in some embodiments in the cooking appliance, it is possible to achieve opening the door by two steps, and achieve unlocking by one button, and achieve a convenient effect of opening the door by a single-hand operation; a screen can be provided on the cooking appliance, and operation and control are carried out through the screen, which is convenient and clear.

The cooking appliance can be an induction cooker, an oven, an integrated steam oven, etc.

In the present application, the term of “multiple” refers to two or more than two, unless otherwise clearly defined. The terms “mount”, “couple”, “connect”, “fix” and the like should be understood in a broad sense, for example, the term “connect” can be a fixed connection, a detachable connection, or an integral connection; the term “couple” can be a direct connection, or an indirect connection through an intermediate medium. For those of ordinary skill in this field, the specific meanings of the above terms in the present application can be understood according to the specific situations.

In the description of the present application, the description of the terms of “an embodiment”, “some embodiments”, “specific embodiment” and the like is intended to mean that the specific features, structures, materials or characteristics described in combination with the embodiments or examples are included in at least one embodiment or example of the present application. In the description, the illustrative expression of the above terms may not indicate the same embodiment or example. In addition, the specific features, structures, materials or characteristics as described may be combined with each other in an appropriate method in one or more of any embodiments or examples.

The above-mentioned are merely some embodiments of the present application and are not intended to limit the present application, and for one skilled in the art, various modifications and changes may be made to the present application. Any modifications, equivalent substitutions, improvements and so on made within the spirit and principle of the present application should be covered within the scope of protection of the present application.

What is claimed:

1. A lock structure for a cooking appliance, wherein, the cooking appliance comprises a cavity assembly and a door assembly which are connected to each other, the lock structure comprises:
a mounting member, configured to be connected to one of the door assembly or the cavity assembly, and the other one of the door assembly or the cavity assembly being provided with a connecting part;
a locking member, connected to the mounting member, wherein, the locking member is configured to move between a locked position and an unlocked position, when in the locked position, the locking member is configured to be connected to the connecting part, and when in the unlocked position, the locking member is separated from the connecting part; and
a limiting member, connected to the mounting member, wherein, when the locking member is located in the locked position and the limiting member operates in a first state, the limiting member is configured to limit the locking member, and when the limiting member operates in a second state, the limiting member releases the locking member.

2. The lock structure according to claim 1, wherein, the locking member is provided with a plug-in part, and the locking member is rotatably connected to the mounting member, when in the locked position, the plug-in part is configured to engage with the connecting part, and the plug-in part is configured to rotate under a pull of the connecting part, to make the locking member rotate towards the unlocked position.

3. The lock structure according to claim 1, wherein, the locking member is provided with a to-be-pushed part, and the to-be-pushed part is configured to be pushed by the connecting part, to make the locking member rotate towards the locked position.

4. The lock structure according to claim 2, wherein, a first side of the plug-in part is provided with a limiting surface, and a second side of the plug-in part is provided with an inclined surface, the limiting surface is configured to limit the connecting part, a first end of the plug-in part is distal from a rotation center of the locking member, from the first end of the plug-in part to a second end of the plug-in part, a distance between the limiting surface and the inclined surface increases.

5. The lock structure according to claim 1, further comprising:
a rotating shaft, which is connected to the mounting member, wherein the locking member is provided with a shaft hole, and the rotating shaft passes through the shaft hole; and
a boss, connected to the rotating shaft, wherein, the locking member is located between the boss and the mounting member, the locking member is provided with a limiting groove, the limiting groove is in communication with the shaft hole, when the boss is misaligned with the limiting groove, the boss is configured to prevent the locking member from disengaging from the rotating shaft, when the boss is aligned with the limiting groove, the boss is configured to pass through the limiting groove.

6. The lock structure according to claim 1, wherein, one of the locking member and the limiting member is provided with a slot, when the locking member is in the locked position and the limiting member operates in the first state, the other one of the locking member and the limiting member is inserted into the slot.

7. The lock structure according to claim 1, wherein, the limiting member comprises:
a solenoid valve body, connected to the mounting member;
an output shaft, connected to the solenoid valve body, in the first state, the output shaft moves to a first position relative to the solenoid valve body, and the output shaft limits the locking member; in the second state, the output shaft moves to a second position, and the output shaft is separated from the locking member.

8. The lock structure according to claim 7, wherein, the limiting member further comprises:
a guiding member, connected to the mounting member, the guiding member is provided with a guiding hole, and the output shaft passes through the guiding hole.

9. The lock structure according to claim 8, wherein, the output shaft comprises:
a shaft body, connected to the solenoid valve body;
a first limiting part, connected to the shaft body, wherein the first limiting part passes through the guiding hole and is configured to limit the locking member; and
a second limiting portion, connected to the first limiting part, wherein, when the output shaft is at the first position, the second limiting part contacts a side of the guiding member away from the locking member.

10. The lock structure according to claim 7, wherein, the limiting member further comprises:
an elastic member, connected to the output shaft and the solenoid valve body, wherein, when the output shaft is at the first position, the elastic member is in an elastically deformed state; when the output shaft is at the second position, the elastic member is in an original state.

11. A cooking appliance, comprising:
a cavity assembly;
a door assembly, connected to the cavity assembly in an openable and closable manner; and
a lock structure comprising:
a mounting member, configured to be connected to one of the door assembly or the cavity assembly, and the other one of the door assembly or the cavity assembly being provided with a connecting part;
a locking member, connected to the mounting member, wherein, the locking member is configured to move between a locked position and an unlocked position, when in the locked position, the locking member is configured to be connected to the connecting part, and when in the unlocked position, the locking member is separated from the connecting part; and
a limiting member, connected to the mounting member, wherein, when the locking member is located in the locked position and the limiting member operates in a first state, the limiting member is configured to limit the locking member, and when the limiting member operates in a second state, the limiting member releases the locking member;
wherein, the mounting member is arranged on one of the cavity assembly and the door assembly, and a connecting part is provided on the other one of the cavity assembly and the door assembly.

12. The cooking appliance according to claim 11, wherein, based on the mounting member being provided on the cavity assembly, the connecting part comprises a door hook.
